(19) United States
(12) Patent Application Publication
(10) Pub. No.: US 2024/0219557 A1
(43) Pub. Date: Jul. 4, 2024

(54) MOVING APERTURE LiDAR

(71) Applicant: Neural Propulsion Systems, Inc., Pleasanton, CA (US)

(72) Inventors: Babak HASSIBI, San Marino, CA (US); Behrooz REZVANI, Petaluma, CA (US); Oguzhan TEKE, Pasadena, CA (US); Ehsan ABBASI, Los Angeles, CA (US)

(73) Assignee: Neural Propulsion Systems, Inc., Pleasanton, CA (US)

(21) Appl. No.: 18/557,040

(22) PCT Filed: Apr. 26, 2022
(86) PCT No.: PCT/US2022/026265

§ 371 Date: Oct. 24, 2023

Related U.S. Application Data
(60) Provisional application No. 63/180,054, filed on Apr. 26, 2021.

(51) Int. Cl. G01S 13/58; G01S 13/86; G01S 17/894; G06F 17/11

(52) U.S. Cl. CPC G01S 13/583; G01S 13/865; G01S 17/894; G06F 17/11

(57) ABSTRACT

Disclosed herein are light detection and ranging (LiDAR) systems and methods of using them. In some embodiments, a LiDAR system comprises an array of optical components and at least one processor coupled to it. The array comprises n1 illuminators configured to illuminate a point in space, and n2 detectors configured to observe the point in space, wherein n1×n2>2 and the illuminators and n2 detectors are situated in a non-collinear arrangement. The at least one processor is configured to determine a first time-of-flight set corresponding to a first location of the LiDAR system at a first time; determine a second time-of-flight set corresponding to a second location of the LiDAR system at a second time; and solve an optimization problem to estimate a position of the target, wherein the optimization problem minimizes a cost function that takes into account the first time-of-flight set and the second time-of-flight set.

### CROSS-REFERENCE TO RELATED APPLICATIONS

This application claims priority to, and hereby incorporates by reference in its entirety, U.S. Provisional Application No. 63/180,054, filed Apr. 26, 2021 and entitled “Moving Aperture LiDAR” (Attorney Docket No. NPS010P).

### BACKGROUND

There is an ongoing demand for three-dimensional (3D) object tracking and object scanning for various applications, one of which is autonomous driving. The wavelengths of some types of signals, such as radar, are too long to provide the sub-millimeter resolution needed to detect smaller objects. Light detection and ranging (LiDAR) systems use optical wavelengths that can provide finer resolution than other types of systems, thereby providing good range, accuracy, and resolution. In general, LiDAR systems illuminate a target area or scene with pulsed laser light and measure how long it takes for reflected pulses to be returned to a receiver.

### BRIEF DESCRIPTION OF THE DRAWINGS

Objects, features, and advantages of the disclosure will be readily apparent from the following description of certain embodiments taken in conjunction with the accompanying drawings in which:

FIG. 1A illustrates a LiDAR system that includes one illuminator and three detectors in accordance with some embodiments.

FIG. 1B illustrates rays that represent optical signals emitted by the illuminator, reflected by the target, and detected by three detectors of the example system of FIG. 1A.

FIG. 1C illustrates the distances traversed by the optical signals between the illuminator, reflected by the target, and detected by three detectors of the example system of FIG. 1A.

FIG. 2A illustrates an example of intersecting ellipsoids in two dimensions.

FIG. 2B illustrates the effect of noise on the distance estimates using the example from FIG. 2A.

FIG. 2C is a closer view of the area around the target from FIG. 2B.

FIG. 2D illustrates an example of the zone of intersection in accordance with some embodiments.

FIG. 3A is an example view from the side of a vehicle equipped with a LiDAR system in accordance with some embodiments.

FIG. 3B is an example view from above a vehicle equipped with a LiDAR system in accordance with some embodiments.

FIG. 4A is a diagram of certain components of a LiDAR system for carrying out target identification and position estimation in accordance with some embodiments.

FIG. 4B is more detailed diagram of the array of optical components of a LiDAR system in accordance with some embodiments.

FIGS. 5A, 5B, and 5C depict an illuminator in accordance with some embodiments.

FIGS. 6A, 6B, and 6C depict a detector in accordance with some embodiments.

FIG. 7A is a view of an example array of optical components in accordance with some embodiments.

FIG. 7B is a simplified cross-sectional view of the example array of optical components at a particular position in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation.

Moreover, the description of an element in the context of one drawing is applicable to other drawings illustrating that element.

### DETAILED DESCRIPTION

Disclosed herein are novel LiDAR systems and methods of using an array of optical components, namely a plurality of illuminators and a plurality of detectors, and knowledge of the movement of the LiDAR system to detect the existence and coordinates (positions) of objects (also referred to herein as targets) in a scene. One application, among many others, of the disclosed LiDAR systems is for scene sensing in autonomous driving or for autonomous transportation.

The disclosed LiDAR systems include a plurality of illuminators (e.g., lasers) and a plurality of optical detectors (e.g., photodetectors, such as avalanche photodiodes (APDs)). The illuminators and detectors may be disposed in an array, which, in autonomous driving applications, may be mounted to the roof of a vehicle or in another location. To allow the LiDAR system to estimate the positions of objects in a three-dimensional scene being sensed, the array of optical components (or, if the illuminators and detectors are considered to be in separate arrays, at least one of the arrays (illuminator and/or detector)) is two-dimensional. Because the positions of multiple targets (e.g., objects) in three-dimensional space are determined using multiple optical signals and/or reflections, the system can be referred to as a multiple-input, multiple-output (MIMO) LiDAR system.

U.S. Patent Publication No. 2021/0041562A1 is the publication of U.S. application Ser. No. 16/988,701, now U.S. Pat. No. 11,047,982, which was filed Aug. 9, 2020, issued on Jun. 29, 2021, and is entitled “DISTRIBUTED APERTURE OPTICAL RANGING SYSTEM.” The entirety of U.S. Patent Publication No. 2021/0041562A1 is hereby incorporated by reference for all purposes. U.S. Patent Publication No. 2021/0041562A1 describes a MIMO LiDAR system and explains various ways that unique illuminator-detector pairs, each having one illuminator and one detector, can be used to determine the positions of targets in a scene. For example, U.S. Patent Publication No. 2021/0041562A1 explains that the positions in three-dimensional space of targets within a volume of space can be determined using a plurality of optical components (each of the optical components being an illuminator or a detector). If the number of illuminators illuminating a specified point in the volume of space is denoted as n₁ and the number of detectors observing that specified point is denoted as n₂, the position of the point can be determined as long as (1) the product of the number of illuminators illuminating that point and the number of detectors observing that point is greater than 2 (i.e., n₁×n₂>2), and (2) the collection of n₁ illuminators and n₂ detectors is non-collinear (i.e., not all of the n₁ illuminator(s) and n₂ detector(s) are arranged in a single straight line, or, stated another way, at least one of the n₁ illuminator(s) and n₂ detector(s) is not on the same straight line as the rest of the n₁ illuminator(s) and n₂ detector(s)). These conditions allow at least three independent equations to be determined so that the position of each target in the volume of space illuminated by the illuminator(s) and observed by the detector(s) can be determined unambiguously.

U.S. Patent Publication No. 2021/0041562A1 explains that there are various combinations of n₁ illuminators and n₂ detectors that can be used to meet the first condition, n₁×n₂>2. For example, one combination can include one illuminator and three detectors. Another combination can include three illuminators and one detector. Still another combination can use two illuminators and two detectors. Any other combination of n₁ illuminators and n₂ detectors, situated non-collinearly, that meets the condition n₁×n₂>2 can be used.

In some aspects, the techniques described herein relate to a light detection and ranging (LiDAR) system, including: an array of optical components, the array including: n₁ illuminators configured to illuminate a point in space, and n₂ detectors configured to observe the point in space, wherein n₁×n₂>2 and the n₁ illuminators and n₂ detectors are situated in a non-collinear arrangement; and at least one processor coupled to the array of optical components and configured to: determine a first time-of-flight set corresponding to a first location of the LiDAR system at a first time, wherein the first time-of-flight set includes a respective entry for each unique illuminator-detector pair of the n₁ illuminators and n₂ detectors, wherein the first time-of-flight set includes, for each unique illuminator-detector pair, a respective measured time-of-flight of a first optical signal emitted by an illuminator of the unique illuminator-detector pair at the first time and from the first location, reflected by a target at the point in space, and detected by a detector of the unique illuminator-detector pair, determine a second time-of-flight set corresponding to a second location of the LiDAR system at a second time, wherein the second time-of-flight set includes a respective entry for each unique illuminator-detector pair of the n₁ illuminators and n₂ detectors, wherein the second time-of-flight set includes, for each unique illuminator-detector pair, a respective measured time-of-flight of a second optical signal emitted by the illuminator of the unique illuminator-detector pair at the second time and from the second location, reflected by the target, and detected by the detector of the unique illuminator-detector pair, and solve an optimization problem to estimate a position of the target, wherein the optimization problem minimizes a cost function that takes into account the first time-of-flight set and the second time-of-flight set.

In some aspects, the techniques described herein relate to a LiDAR system, wherein the cost function is a function of at least (a) coordinates of the n₁ illuminators, (b) coordinates of the n₂ detectors, (c) the first time-of-flight set, and (d) the second time-of-flight set.

In some aspects, the techniques described herein relate to a LiDAR system, wherein the cost function is quadratic.

In some aspects, the techniques described herein relate to a LiDAR system, wherein the at least one processor is configured to solve the optimization problem, in part, by minimizing a sum of (a) squared differences between each entry in the first time-of-flight set and a respective first estimated time-of-flight, wherein the respective first estimated time-of-flight is calculated from known coordinates of the respective illuminator-detector pair at the first time and an unknown position of the target, and (b) squared differences between each entry in the second time-of-flight set and a respective second estimated time-of-flight, wherein the respective second estimated time-of-flight is calculated from known coordinates of the respective illuminator-detector pair at the second time and the unknown position of the target.

In some aspects, the techniques described herein relate to a LiDAR system, wherein the n₁ illuminators comprise a first illuminator and a second illuminator and the n₂ detectors comprise a first detector and a second detector.

In some aspects, the techniques described herein relate to a LiDAR system, wherein the optimization problem is

$${min}_{X} {\sum }_{t = 1}^{2} {( ‖ X - {l}_{t , 1} ‖ + ‖ X - {a}_{t , 1} ‖ - c {τ}_{t , 11} )}^{2} + {( ‖ X - {l}_{t , 1} ‖ + ‖ X - {a}_{t , 2} ‖ - c {τ}_{t , 12} )}^{2} + {( ‖ X - {l}_{t , 2} ‖ + ‖ X - {a}_{t , 1} ‖ - c {τ}_{t , 21} )}^{2} + {( ‖ X - {l}_{t , 2} ‖ + ‖ X - {a}_{t , 2} ‖ - c {τ}_{t , 22} )}^{2}$$

wherein: X is a first vector representing the position of the target, l_{t,1} is a second vector representing coordinates of the first illuminator at a time t, l_{t,2} is a third vector representing coordinates of the second illuminator at the time t, α_{t,1} is a fourth vector representing coordinates of the first detector at the time t, α_{t,2} is a fifth vector representing coordinates of the second detector at the time t, c is a speed of light, τ_{t,11} is the measured time-of-flight of the first optical signal emitted by the first illuminator at the time t, reflected by the target, and detected by the first detector, τ_{t,12} is the measured time-of-flight of the first optical signal emitted by the first illuminator at the time t, reflected by the target, and detected by the second detector, τ_{t,21} is the measured time-of-flight of the first optical signal emitted by the second illuminator at the time t, reflected by the target, and detected by the first detector, and τ_{t,22} is the measured time-of-flight of the first optical signal emitted by the second illuminator at the time t, reflected by the target, and detected by the second detector.

In some aspects, the techniques described herein relate to a LiDAR system, wherein the at least one processor is further configured to: determine a third time-of-flight set corresponding to a third location of the LiDAR system at a third time, wherein the third time-of-flight set includes a respective entry for each unique illuminator-detector pair of the n₁ illuminators and n₂ detectors, wherein the third time-of-flight set includes, for each unique illuminator-detector pair, a respective measured time-of-flight of a third optical signal emitted by the illuminator of the unique illuminator-detector pair at the third time and from the third location, reflected by the target, and detected by the detector of the unique illuminator-detector pair, and wherein the cost function takes into account the third time-of-flight set.

In some aspects, the techniques described herein relate to a LiDAR system, wherein the n₁ illuminators comprise a first illuminator and a second illuminator and the n₂ detectors comprise a first detector and a second detector, and wherein the optimization problem is

$${min}_{X} {\sum }_{t = 1}^{3} {( ‖ X - {l}_{t , 1} ‖ + ‖ X - {a}_{t , 1} ‖ - c {τ}_{t , 11} )}^{2} + {( ‖ X - {l}_{t , 1} ‖ + ‖ X - {a}_{t , 2} ‖ - c {τ}_{t , 12} )}^{2} + {( ‖ X - {l}_{t , 2} ‖ + ‖ X - {a}_{t , 1} ‖ - c {τ}_{t , 21} )}^{2} + {( ‖ X - {l}_{t , 2} ‖ + ‖ X - {a}_{t , 2} ‖ - c {τ}_{t , 22} )}^{2}$$

wherein: X is a first vector representing the position of the target, l_{t,1} is a second vector representing coordinates of the first illuminator at a time t, l_{t,2} is a third vector representing coordinates of the second illuminator at the time t, α_{t,1} is a fourth vector representing coordinates of the first detector at the time t, α_{t,2} is a fifth vector representing coordinates of the second detector at the time t, c is a speed of light, τ_{t,11} is the measured time-of-flight of the first optical signal emitted by the first illuminator at the time t, reflected by the target, and detected by the first detector, τ_{t,12} is the measured time-of-flight of the first optical signal emitted by the first illuminator at the time t, reflected by the target, and detected by the second detector, τ_{t,21} is the measured time-of-flight of the first optical signal emitted by the second illuminator at the time t, reflected by the target, and detected by the first detector, and τ_{t,22} is the measured time-of-flight of the first optical signal emitted by the second illuminator at the time t, reflected by the target, and detected by the second detector.

In some aspects, the techniques described herein relate to a LiDAR system, wherein the at least one processor is further configured to: determine at least one additional time-of-flight set corresponding to respective at least one additional location of the LiDAR system at at least one respective time, wherein the at least one additional time-of-flight set includes a respective entry for each unique illuminator-detector pair of the n₁ illuminators and n₂ detectors, wherein the at least one additional time-of-flight set includes, for each unique illuminator-detector pair, a respective measured time-of-flight of a third optical signal emitted by the illuminator of the unique illuminator-detector pair at time and from the third location, reflected by the target, and detected by the detector of the unique illuminator-detector pair, and wherein the cost function takes into account the third time-of-flight set.

In some aspects, the techniques described herein relate to a LiDAR system, further including an inertial navigation system (INS) or a Global Navigation Satellite System (GNSS) coupled to the at least one processor and configured to: determine a first estimate of the first location of the LiDAR system at the first time and/or determine a second estimate of the second location of the LiDAR system at the second time, and wherein the at least one processor is further configured to obtain the first estimate and/or the second estimate from the INS or GNSS.

In some aspects, the techniques described herein relate to a LiDAR system, wherein the at least one processor is further configured to: estimate a motion of the target.

In some aspects, the techniques described herein relate to a LiDAR system, further including a radar subsystem coupled to the at least one processor, and wherein the at least one processor is configured to estimate the motion of the target using Doppler information obtained from the radar subsystem.

In some aspects, the techniques described herein relate to a method performed by a LiDAR system including at least three unique illuminator-detector pairs, each of the at least three unique illuminator-detector pairs having one of n₁ illuminators configured to illuminate a volume space and one of n₂ detectors configured to observe the volume of space, wherein n₁×n₂>2, and wherein the n₁ illuminators and n₂ detectors are situated in a non-collinear arrangement, the method comprising: at each of a plurality of locations of the LiDAR system, each of the plurality of locations corresponding to a respective time, for each of the at least three unique illuminator-detector pairs, measuring a respective time-of-flight of a respective optical signal emitted by the illuminator, reflected by a target in the volume of space, and detected by the detector; and solving an optimization problem to estimate a position of the target.

In some aspects, the techniques described herein relate to a method, wherein the optimization problem minimizes a cost function that takes into account at least a subset of the measured times of flight.

In some aspects, the techniques described herein relate to a method, wherein the cost function is a function of at least (a) positions of the n₁ illuminators, (b) positions of the n₂ detectors, and (c) the at least a subset of the measured times of flight.

In some aspects, the techniques described herein relate to a method, wherein the cost function is quadratic.

In some aspects, the techniques described herein relate to a method, wherein solving the optimization problem includes minimizing a sum of squared differences.

In some aspects, the techniques described herein relate to a method, wherein the n₁ illuminators comprise a first illuminator and a second illuminator and the n₂ detectors comprise a first detector and a second detector, and wherein the optimization problem is

$${min}_{X} {\sum }_{t = 1}^{2} {( ‖ X - {l}_{t , 1} ‖ + ‖ X - {a}_{t , 1} ‖ - c {τ}_{t , 11} )}^{2} + {( ‖ X - {l}_{t , 1} ‖ + ‖ X - {a}_{t , 2} ‖ - c {τ}_{t , 12} )}^{2} + {( ‖ X - {l}_{t , 2} ‖ + ‖ X - {a}_{t , 1} ‖ - c {τ}_{t , 21} )}^{2} + {( ‖ X - {l}_{t , 2} ‖ + ‖ X - {a}_{t , 2} ‖ - c {τ}_{t , 22} )}^{2}$$

wherein: X is a first vector representing the position of the target, τ_{t,1} is a second vector representing coordinates of the first illuminator at a time t, l_{t,2} is a third vector representing coordinates of the second illuminator at the time t, α_{t,1} is a fourth vector representing coordinates of the first detector at the time t, α_{t,2} is a fifth vector representing coordinates of the second detector at the time t, c is a speed of light, τ_{t,11} is the measured time-of-flight of the respective optical signal emitted by the first illuminator at the time t, reflected by the target, and detected by the first detector, τ_{t,12} is the measured time-of-flight of the respective optical signal emitted by the first illuminator at the time t, reflected by the target, and detected by the second detector, τ_{t,21} is the measured time-of-flight of the respective optical signal emitted by the second illuminator at the time t, reflected by the target, and detected by the first detector, and τ_{t,22} is the measured time-of-flight of the respective optical signal emitted by the second illuminator at the time t, reflected by the target, and detected by the second detector.

In some aspects, the techniques described herein relate to a method, wherein the optimization problem is

$${min}_{X} {\sum }_{t = 1}^{T} {\sum }_{i = 1}^{{n}_{1}} {\sum }_{j = 1}^{{n}_{2}} f ( {‖ X - {l}_{t , i} ‖}_{2} + {‖ X - {a}_{t , j} ‖}_{2} - c \cdot {τ}_{t , i , j} )$$

wherein: X is a first vector representing the position of the target, l_{t,i} is a second vector representing coordinates of an ith illuminator of the n₁ illuminators at a time t, α_{t,j} is a third vector representing coordinates of a jth detector of the n₂ detectors at the time t, c is a speed of light, τ_{t,ij} is the measured time-of-flight of the respective optical signal emitted by the ith illuminator at the time t, reflected by the target, and detected by the jth detector, T is a number of measurements, and ƒ(·) is a cost function.

In some aspects, the techniques described herein relate to a method, wherein the cost function is quadratic.

In some aspects, the techniques described herein relate to a method, wherein a value of T is at least ten.

In some aspects, the techniques described herein relate to a method, further including: estimating each of the plurality of locations using an inertial navigation system (INS) or a Global Navigation Satellite System (GNSS).

In some aspects, the techniques described herein relate to a method, further including: estimating a motion of the target.

In some aspects, the techniques described herein relate to a method, wherein estimating the motion of the target includes obtaining Doppler information from a radar subsystem.

In some aspects, the techniques described herein relate to a method, wherein the optimization problem jointly estimates the position of the target and the motion of the target.

In the following description, some embodiments include pluralities of components or elements.

These components or elements are referred to generally using a reference number alone (e.g., illuminator(s) 120, detector(s) 130, optical signal(s) 121), and specific instances of those components or elements are referred to and illustrated using a reference number followed by a letter (e.g., illuminator 120A, detector 130A, optical signal 121A). It is to be understood that the drawings may illustrate only specific instances of components or elements (with an appended letter), and the specification may refer to those illustrated components or elements generally (without an appended letter).

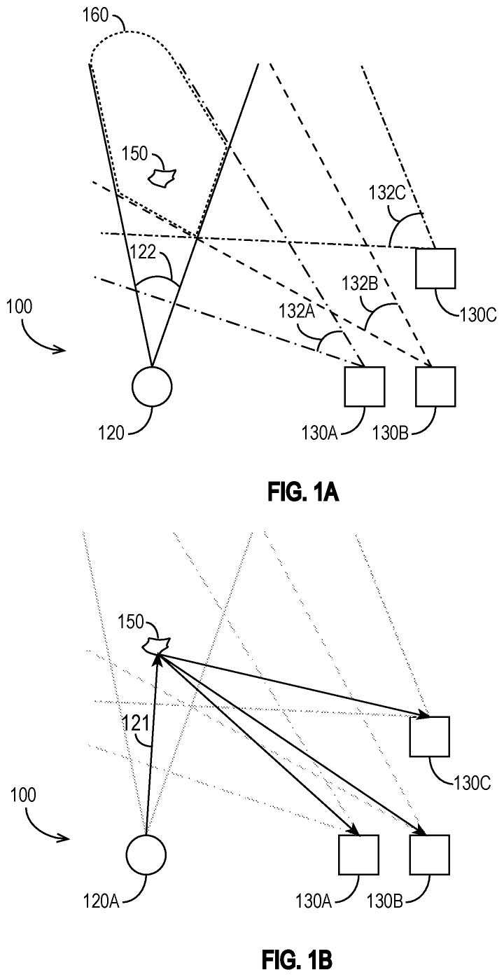

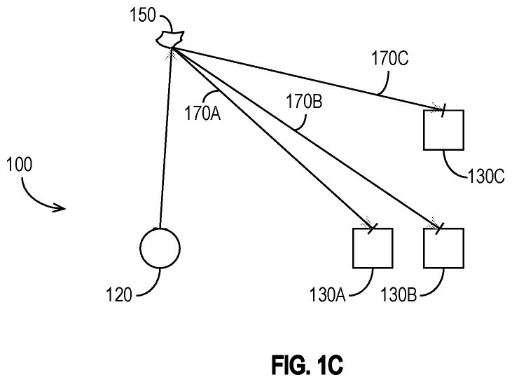

FIG. 1A illustrates an exemplary LiDAR system 100 that includes one illuminator 120 and three detectors 130, namely detector 130A, detector 130B, and detector 130C. As explained above, the system may have any number of illuminators 120 and detectors 130, and various unique illuminator-detector pairs can be used to determine targets' positions. Therefore, FIG. 1A is merely illustrative. The illuminator 120 illuminates a volume of space 160 (shown as a projection in a plane in two dimensions, but it is to be appreciated that the volume of space 160 is three dimensional), and the three detectors 130, namely detector 130A, detector 130B, and detector 130C, observe the volume of space 160. The illuminator 120 has an illuminator field of view (FOV) 122, illustrated in two dimensions as an angle, and the detector 130A, detector 130B, and detector 130C have, respectively, detector FOV 132A, detector FOV 132B, and detector FOV 132C, which are also illustrated, in two dimensions, as angles. Each of the detector FOV 132A, the detector FOV 132B, and the detector FOV 132C shown in FIG. 1A intersects at least a portion of the illuminator FOV 122. The intersection of the illuminator FOV 122 and each of the detector FOV 132A, the detector FOV 132B, and the detector FOV 132C is the volume of space 160.

Although FIG. 1A illustrates only two dimensions, it is to be understood that the illuminator FOV 122, the detector FOV 132A, the detector FOV 132B, and the detector FOV 132C, and the volume of space 160 are all, in general, three-dimensional. Furthermore, although FIG. 1A illustrates an exemplary LiDAR system 100 that uses one illuminator 120 and three detectors 130 there are other combinations of numbers of illuminators 120 and detectors 130 that can also be used to detect the positions of targets (e.g., three illuminators 120 and one detector 130, two illuminators 120 and two detectors 130, etc.). In general, and as explained above, any combination of illuminators 120 and detectors 130 that meets the conditions of n₁×n₂>2 and non-collinearity of the set of illuminators 120 and detectors 130 can be used.

FIG. 1A illustrates a target 150 within the range of the LiDAR system 100. For simplicity, only a single target 150 is illustrated; it is to be appreciated that a scene can include many targets 150, some or all of which can be detected by the LiDAR system 100 in the same manner as described for the illustrated target 150. The target 150 illustrated in FIG. 1A is within the volume of space 160 defined by the illuminator FOV 122, the detector FOV 132A, the detector FOV 132B, and the detector FOV 132C, and, therefore, the position of the target 150 within the volume of space 160 can be determined using the illuminator 120, the detector 130A, the detector 130B, and the detector 130C.

In some embodiments, to determine the position of the target 150, the LiDAR system 100 determines, for each of the detector 130A, the detector 130B, and the detector 130C, an estimate of the distance traversed by an optical signal emitted by the illuminator 120 of the unique illuminator-detector pair, reflected by the target 150, and detected by each of the detector 130A, the detector 130B, and the detector 130C. Alternatively, or in addition, the LiDAR system 100 can determine, for each optical path, the round-trip time of the optical signal emitted by the illuminator 120 of the unique illuminator-detector pair, reflected by the target 150, and detected by each of the detector 130A, the detector 130B, and the detector 130C. The distances traveled by these optical signals are easily computed from times-of-flight by multiplying the times-of-flight by the speed of light.

FIG. 1B illustrates rays that represent optical signals 121 emitted by the illuminator 120, reflected by the target 150, and detected by the detector 130A, the detector 130B, and the detector 130C. FIG. 1C illustrates the distances traversed by the optical signals 121 between the illuminator 120, the target 150, and the detector 130A, the detector 130B, and the detector 130C. Specifically, the optical signal 121 emitted by the illuminator 120 and reflected by the target 150 traverses a distance 170A before being detected by the detector 130A, a distance 170B before being detected by the detector 130B, and a distance 170C before being detected by the detector 130C. (It is to be appreciated that each of the distance 170A, the distance 170B, and the distance 170C includes the distance between the illuminator 120 and the target 150.)

As described further below, the LiDAR system 100 includes at least one processor 140 coupled to the array of optical components 110. The at least one processor 140 has an accurate indication of when the optical signal 121 is emitted by the illuminator 120 and can estimate the round-trip distances (e.g., in the example of FIGS. 1A, 1B and 1C, the distance 170A, the distance 170B, and the distance 170C) from the times-of-flight of the optical signal emitted by the illuminator 120. In other words, knowing when the illuminator 120A emitted the optical signal, the at least one processor 140 can use the arrival times of the optical signals at the detector 130A, the detector 130B, and the detector 130C to estimate the distance 170A, the distance 170B, and the distance 170C traversed by the optical signals 121 by multiplying the respective times-of-flight of the optical signals 121 by the speed of light (299792458 m/s).

The estimated distance corresponding to each illuminator-detector pair defines an ellipsoid that has one focal point at the coordinates of the illuminator 120 and the other focal point at the coordinates of the detector 130. The ellipsoid is defined as those points in space whose sums of distances from the two focal points are given by the estimated distance. The detected target resides somewhere on this ellipsoid. For example, referring again to the example illustrated in FIGS. 1A through 1C, the target 150 resides on each of three ellipsoids, each corresponding a unique illuminator-detector pair (in the example shown in FIGS. 1A through 1C, illuminator 120 and detector 130A, illuminator 120 and detector 130B, and illuminator 120 and detector 130C). Each of the three ellipsoids has one focal point at the coordinates of the illuminator 120. A first ellipsoid has its other focal point at the coordinates of the detector 130A. A second ellipsoid has its other focal point at the coordinates of the detector 130B. A third ellipsoid has its other focal point at the coordinates of the detector 130C. Because the collection of the illuminator 120 and the detector 130A, the detector 130B, and the detector 130C is non-collinear, and the target 150 resides on each of the ellipsoids, the position of the target 150 is at the intersection of the three ellipsoids that lies within the volume of space 160. This intersection, and, therefore, the coordinates of the target 150, can be determined, for example, by solving a system of quadratic equations, as explained in detail in U.S. Patent Publication No. 2021/0041562A1.

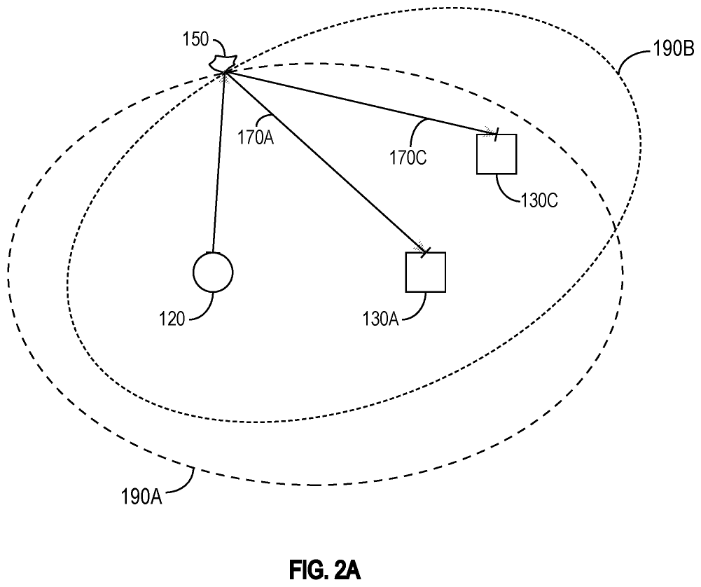

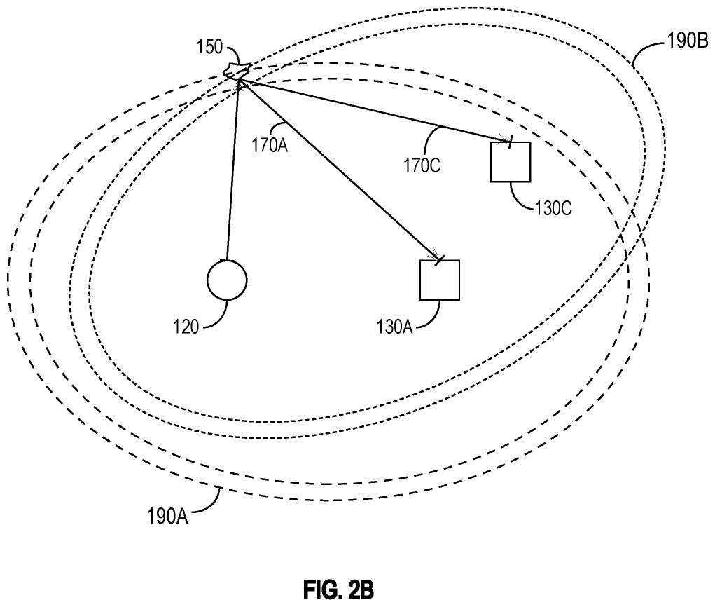

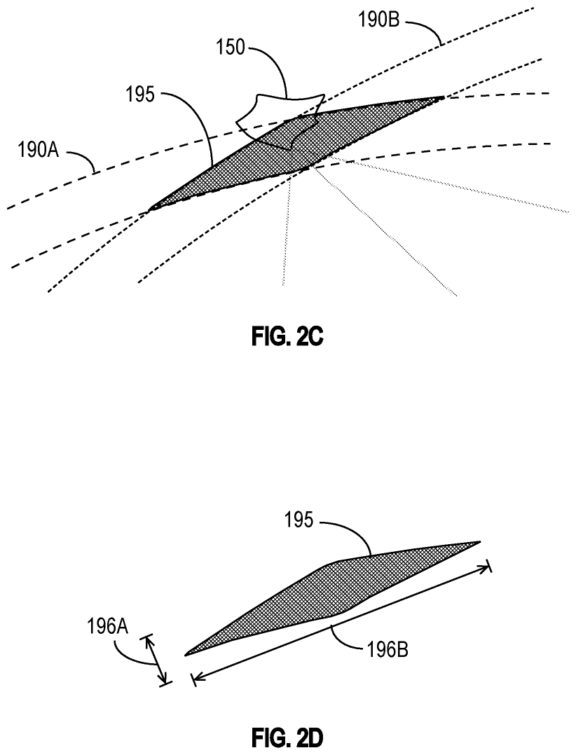

FIG. 2A illustrates an example of intersecting ellipsoids in two dimensions. Specifically, FIG. 2A shows an ellipse 190A and an ellipse 190B (which are projections of two intersecting ellipsoids onto a plane) for the example shown in FIGS. 1A through 1C. The ellipse 190A has foci at the positions of the illuminator 120 and the detector 130A, and the ellipse 190B has foci at the positions of the illuminator 120 and the detector 130C. As shown, the ellipse 190A and ellipse 190B intersect at the location of the target 150 within the volume of space 160. The position of the target 150 relative to the LiDAR system 100 in the plane of the illustrated projections is the point of intersection of the ellipse 190A and the ellipse 190B. In three dimensions, the intersection of three ellipsoids (e.g., adding the ellipsoid with foci at the positions of the illuminator 120 and the detector 130B) provides the position of the target 150 in three-dimensional space (in this example, within the volume of space 160).

In theory, the ellipsoids (in three dimensions) intersect at exactly one point in the volume of space 160, which is in front of the LiDAR system 100 (namely, at the location where the target 150 is; of course, there is also an intersection point behind the LiDAR system 100, but that point is behind the LiDAR system 100 and is known not to be the position of the target 150). Ideally, this point of intersection is the precise location of the target 150 within the volume of space 160. In reality, however, practical systems can suffer from noise due to, for example, jitter, background noise, and other sources. As a result, the time-of-flight (TOF) estimates, and therefore the distance estimates, are not necessarily precise. For example, each TOF estimate can be expressed as \tilde{t}ₖ=tₖ+δₖ, where \tilde{t}ₖ is the estimated TOF, tₖ is the true TOF (the time elapsing between when the optical signal is emitted by the illuminator 120, reflected by the target 150, and detected by the kth detector 130), and δₖ is the noise in the kth TOF estimate. The amount and characteristics (e.g., level, variance, distribution, etc.) of the noise δₖ depend on a number of factors that will be apparent to those having ordinary skill in the art. For purposes of example, for a LiDAR system 100 used for autonomous driving, it can be assumed that the value of δₖ results in uncertainty in the distance estimates between approximately 1 mm and 1 cm.

The effect of the uncertainty (noise) in the TOF estimates (and, therefore, in the distance estimates) can be visualized as a “thickening” of the surfaces of the ellipsoids defined by the positions of the illuminator 120 and detector 130 pairs. FIG. 2B illustrates the effect of noise on the distance estimates using the example from FIG. 2A. Each of the ellipse 190A and the ellipse 190B is shown as a band. The single point of intersection shown in FIG. 2A is now a zone of intersection in FIG. 2B. The position of the target 150 could be anywhere within the zone of intersection.

FIG. 2C is a closer view of the area around the target 150. As shown in FIG. 2C, the zone of intersection 195 results from the noise in the TOF and distance estimates causing the ellipse 190A and the ellipse 190B (and the corresponding ellipsoids) to have thicker boundaries (ellipsoid surfaces). FIG. 2D shows that the zone of intersection 195 has non-zero maximum dimensions, namely a maximum dimension 196A and a maximum dimension 196B, which may be, for example, in a direction orthogonal to the direction of the maximum dimension 196A. If the plane represented by FIGS. 2A and 2B is, for example, a horizontal plane, then the maximum dimension 196A and the maximum dimension 196B represent the possible locations in the horizontal plane where the target 150 could be.

It is to be appreciated that FIGS. 2A through 2D illustrate only two dimensions. In three dimensions, the effect of the third ellipsoid (e.g., corresponding to the illuminator 120 and the detector 130B) is to make the zone of intersection a volume in three-dimensional space.

The size of the zone of intersection 195 (whether in two or three dimensions) depends not only on the characteristics of the noise affecting the TOF and distance estimates, but also on the relative locations of the unique illuminator-detector pairs used to determine the location of the target 150. When the illuminator(s) 120 and detector(s) 130 are near each other, the ellipsoids are similar to each other, which results in the zone of intersection 195 being relatively large.

As an example, a LiDAR system 100 used for autonomous driving may be mounted on the roof of a vehicle. Because of size constraints, the maximum width of the array of illuminators 120 and detectors 130 is the width of the vehicle's roof. The maximum height of the array will likely be considerably less in order not to adversely affect the aerodynamics and use of the vehicle. As a result, assuming the plane of FIG. 2D is a horizontal plane, the maximum dimension 196A will likely be on the order of a few millimeters, and the maximum dimension 196B will likely be on the order of a few centimeters. Thus, the angular position is imprecise. For such a system, the third dimension, corresponding to the maximum span of the zone of intersection 195 in the vertical direction (elevation) will likely be even larger.

An industry objective for the accuracy of a LiDAR system for autonomous driving is between 0.1 and 0.2 degrees in both azimuth and elevation. For a target that is, for example, 10 meters away, this objective translates to approximately 1.8-3.6 mm positional accuracy in both directions. The zone of intersection 195 resulting from the intersection of three ellipsoids as described above may be too large to resolve the position of the target 150 to meet this objective in some applications.

Therefore, in accordance with some embodiments, to improve the accuracy of the estimates of the positions of targets 150 in a scene, the LiDAR system 100 refines the estimates by taking into account the movement of the LiDAR system 100 relative to the targets 150.

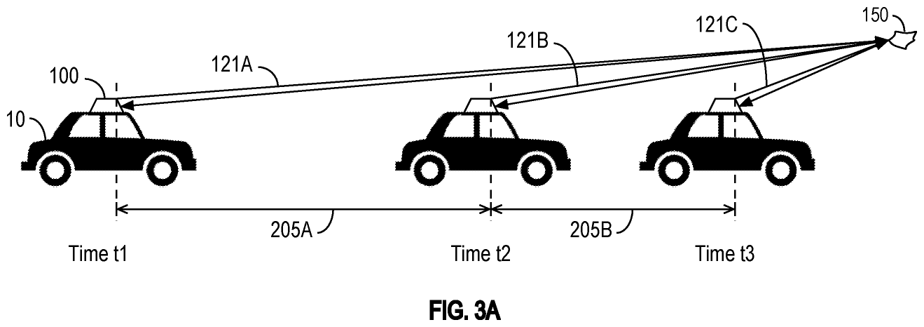

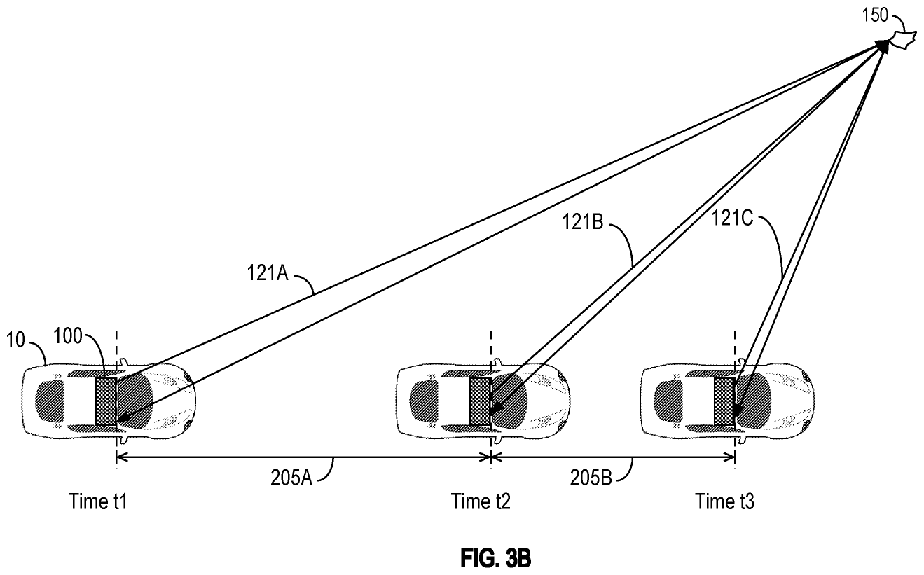

To illustrate, FIGS. 3A and 3B show a vehicle 10 in motion equipped with a LiDAR system 100 in accordance with some embodiments. FIG. 3A is a view from the side of the vehicle 10, and FIG. 3B is a view from above the vehicle 10. Although not specifically labeled in FIGS. 3A and 3B, the LiDAR system 100 includes an array of optical components 110 that includes illuminator(s) 120 and detector(s) 130.

In the example shown in FIGS. 3A and 3B, there is a target 150 in front of and to the left side of the vehicle 10. At time t1, the LiDAR system 100, which is at a first position, emits a first optical signal 121A, which is reflected by the target 150 and detected by at least one detector 130 of the LiDAR system 100. (For example, referring again to FIGS. 1A through 1C, one illuminator 120 may emit the first optical signal 121A, and three detectors, e.g., detector 130A, detector 130B, and detector 130C, may detect the reflections of the optical signal 121A off the target 150.) The LiDAR system 100 can compute the TOF corresponding to (and distance traversed by) the optical signal 121A for each unique illuminator-detector pair. As explained above, the positions of the illuminator 120 and detector 130 of each unique illuminator-detector pair are the foci of an ellipsoid on which the target 150 lies. Because of noise in the TOF estimates, the ellipsoids defined by at least three unique illuminator-detector pairs intersect to form a zone of intersection 195, as described above, and it is known that the target 150 is somewhere within this zone of intersection.

Between time t1 and time t2, the vehicle 10 moves a distance 205A. At a time t2, the LiDAR system 100, which is at a second position, emits a second optical signal 121B, which is reflected by the target 150 and detected by at least one detector 130 of the LiDAR system 100. (For example, referring again to FIGS. 1A through 1C, one illuminator 120 may emit the first optical signal 121B, and three detectors 130, e.g., detector 130A, detector 130B, and detector 130C may detect the reflections of the optical signal 121B off the target 150.) As explained previously, the positions of the illuminator 120 and detector 130 of each unique illuminator-detector pair are the foci of an ellipsoid on which the target 150 lies. Because the vehicle 10 and the LiDAR system 100 are now closer to the target 150, the ellipsoids will have different sizes and orientations than when the LiDAR system 100 was in the first position at time t1. Assuming the target 150 has not moved, it will still lie within the zone of intersection 195, which can be further refined (made smaller) by including the ellipsoids corresponding to the distance estimates made using the optical signal 121B (emitted at time t2). In other words, instead of the zone of intersection 195 being defined only by the (three or more) ellipsoids using estimates at time t1, the zone of intersection 195 is defined by both the ellipsoids using estimates at time t1 and ellipsoids using estimates at time t2. Because of the different sizes and orientations of the ellipsoids corresponding to the estimates made at time t2, the zone of intersection 195 will be smaller after time t2 than it was after time t1.

Similarly, between time t2 and time t3, the vehicle 10 moves a distance 205B (which may be the same as (e.g., if the vehicle 10 is traveling at a constant speed and the difference between t3 and t2 is equal to the difference between t2 and t1) or different from the distance 205A (e.g., if the vehicle 10 is accelerating or decelerating, and/or the difference between t3 and t2 is not the same as the difference between t2 and t1). At a time t3, the LiDAR system 100, which is now at a third position, emits a third optical signal 121C, which is reflected by the target 150 and detected by at least one detector 130 of the LiDAR system 100. As before, the positions of the illuminator 120 and detector 130 of each unique illuminator-detector pair are the foci of an ellipsoid on which the target 150 lies. Because the vehicle 10 and the LiDAR system 100 are now even closer to the target 150, the ellipsoids will have different sizes and orientations than when the LiDAR system 100 was in the first and second positions (at t1 and t2). Assuming the target 150 has not moved, it will still lie within the zone of intersection 195, which can be further refined (made smaller) by including the ellipsoids corresponding to the distance estimates made using the optical signal 121C (emitted at time t3). In other words, the zone of intersection 195 is defined by the ellipsoids based on estimates at time t1, ellipsoids based on estimates at time t2, and ellipsoids based on estimates at time t3. Because of the different sizes and orientations of the ellipsoids corresponding to the optical signals 121A, 121B, and 121C, the zone of intersection 195 will be even smaller after time t3 than it was after time t2.

As will be appreciated, the zone of intersection can be further refined, and the location of the target 150 more precisely determined/estimated, by incorporating additional measurements and by accounting for the change in location of the LiDAR system 100, and the corresponding change in the angular position of the LiDAR system 100 (and the illuminator(s) 120 and detector(s) 130) relative to the target(s) 150 between measurements. A change in the location of the LiDAR system 100 essentially provides “additional” illuminator-detector pairs at additional locations (the locations they are in after the LiDAR system 100 has moved). An optimization problem can be used (solved) to find the coordinates of the target 150. For example, the optimization can minimize the sum of the squared differences between the “measured” times-of-flight and those calculated from the (known) positions of the illuminator-detector pairs and the (unknown) position of the target.

As a specific example, assume that two illuminators, namely an illuminator 120A and an illuminator 120B, and two detectors, namely a detector 130A and a detector 130B, are used to determine the position of a target 150. If the 3D coordinates of the target 150 are in the vector X and the 3D coordinates of the illuminator 120A, the illuminator 120B, the detector 130A, and the detector 130B at different times t are, respectively, in the vectors l_{t,1}, l_{t,2}, α_{t,1}, and α_{t,2}, then the optimization problem can be written as

$${min}_{X} {\sum }_{t = 1}^{T} {( ‖ X - {l}_{t , 1} ‖ + ‖ X - {a}_{t , 1} ‖ - c {τ}_{t , 11} )}^{2} + {( ‖ X - {l}_{t , 1} ‖ + ‖ X - {a}_{t , 2} ‖ - c {τ}_{t , 12} )}^{2} + {( ‖ X - {l}_{t , 2} ‖ + ‖ X - {a}_{t , 1} ‖ - c {τ}_{t , 21} )}^{2} + {( ‖ X - {l}_{t , 2} ‖ + ‖ X - {a}_{t , 2} ‖ - c {τ}_{t , 22} )}^{2}$$

where τ_{t,ij} denotes the measured time-of-flight from illuminator i to detector j for the measurement made at time t. Note that without motion, the above optimization over the unknown target coordinates X has only 4 terms in this example. If, due to motion, there are multiple measurements T, then the optimization has 4T terms in this example. This will lead to a much more accurate estimate of the location of the target 150.

For an arbitrary number n₁ of illuminators 120 and an arbitrary number n₂ of detectors 130, the optimization problem can be written as

$${min}_{X} {\sum }_{t = 1}^{T} {\sum }_{i = 1}^{{n}_{1}} {\sum }_{j = 1}^{{n}_{2}} f ( {‖ X - {l}_{t , i} ‖}_{2} + {‖ X - {a}_{t , j} ‖}_{2} - c \cdot {τ}_{t , i , j} )$$

where X is a vector of the 3D coordinates of the target 150, l_{t,i} and α_{t,j} are the positions (e.g., coordinates, e.g., as vectors) of the ith illuminator and the jth detector at time t, respectively, τ_{t,i,j} denotes the measured time-of-flight from illuminator i to detector j for the measurement made at time t, T is the number measurements made at different times (e.g., t1, t2, etc.) and corresponding positions, and c is the speed of light. The function ƒ(·) is a cost function that can be chosen based on prior knowledge of the noise and/or error statistics of the times-of-flight. For example, under a Gaussian error model, the cost function may be quadratic, such as, ƒ(x)=x². Other cost functions may be used. Note that without motion, the above optimization over the unknown target coordinates X has only n₁×n₂ terms. If, due to motion, there are multiple measurements T, the optimization has T×(n₁×n₂) terms, which will, in general, lead to a much more accurate estimate of the location of the target 150, as explained above.

As a more specific example, assume that the LiDAR system 100 has a probing rate of 10 frames per second, meaning that it emits one or more optical signals 121 every 100 ms (and, therefore, that it detects reflections approximately every 100 ms). In other words, the LiDAR system 100 takes a “snapshot” of the region of interest every 100 ms. Assume that the LiDAR system 100 is being used in a vehicle 10 that is traveling at a constant speed of 10 meters per second (approximately 22.3 miles per hour). Between frames (or snapshots), the vehicle 10 travels 1 meter. The locations of the LiDAR system 100 at the times of the frames can be used to more accurately resolve the position of the target(s) 150 as described above. Improvements on the order of a factor of ten or more are achievable by using additional measurements to resolve the position of the target(s) 150. For example, by using 10 measurements, a ten-fold improvement in accuracy is achievable. Referring again to FIG. 2D, if the maximum dimension 196B of the zone of intersection 195 using measurements/estimates at a single instant in time (and position) is D, it can be reduced to approximately D/10 by using an additional nine measurements/estimates at nine other positions/instants in time (a total of 10 measurement times/positions instead of only one). By incorporating additional measurements, the industry objective of 0.1-0.2 mm resolution in both azimuth and elevation can be achieved by the LiDAR system 100.

Although FIGS. 3A and 3B illustrate only single optical signals 121, namely the optical signal 121A, the optical signal 121B, and the optical signal 121C, being emitted at, respectively, times t1, t2, and t3, it is to be understood that the LiDAR system 100 can emit many optical signals 121 at any time (e.g., using multiple illuminators 120 for each frame) and/or detect reflections using multiple detectors 130 in order to estimate the position of the target 150. Moreover, because of the speed of light, the position of the vehicle 10 changes negligibly between when an optical signal 121 is emitted and when the reflection(s) of that optical signal 121 is/are detected. For example, if the target 150 is 20 meters from the vehicle 10, and the vehicle is traveling at 20 m/s (approximately 44.7 miles per hour), the round-trip time of the optical signal 121 is approximately 132 ns, during which time the vehicle 10 would have moved by only 2.6 microns.

Changes in the position of the LiDAR system 100 relative to the target(s) 150 can be determined and tracked with high accuracy using, for example, an inertial navigation system (INS) (e.g., any type of navigation device that uses, for example, a computer/processor, motion sensor(s) (e.g., accelerometer(s)), and/or rotation sensor(s) (e.g., gyroscopes) to continuously or periodically calculate by dead reckoning the position, orientation, and/or velocity (direction and speed of movement) of a moving object without the need for external references). Inertial navigation systems are sometimes also referred to as inertial guidance systems or an inertial instruments. As will be appreciated by those having ordinary skill in the art, an INS uses measurements provided by, for example, accelerometers and gyroscopes to track the position and orientation of an object relative to a known starting point, orientation, and velocity. As is known in the art, inertial navigation systems provide very accurate relative position information.

In addition or as an alternative to using an INS, changes in the position of the LiDAR system 100 relative to the target(s) 150 can be determined and tracked using a Global Navigation Satellite System (GNSS). As will be appreciated by those having ordinary skill in the art, a GNSS is a satellite navigation system that provides autonomous geo-spatial positioning with global coverage. Examples of GNSS include, for example, the GPS system in the United States, the GLONASS system in Russia, the Galileo system in Europe, and the BeiDou system in China. Regional systems can also be considered GNSS (e.g., the Quasi-Zenith Satellite System (QZSS) in Japan, and the Indian Regional Navigation Satellite System (IRNSS), also referred to as NavIC, in India). A GNSS receiver can triangulate the position of the MIMO LiDAR system using the distance from at least four GNSS satellites and can provide positional accuracy within a few centimeters.

The discussion above assumes that although the LiDAR system 100 moves relative to the target 150, the target 150 remains stationary. When the target 150 is also moving, Doppler information (e.g., from radar) can be used to incorporate the motion of the target 150 in the optimization. Alternatively, or in addition, the target location and speed can be jointly estimated.

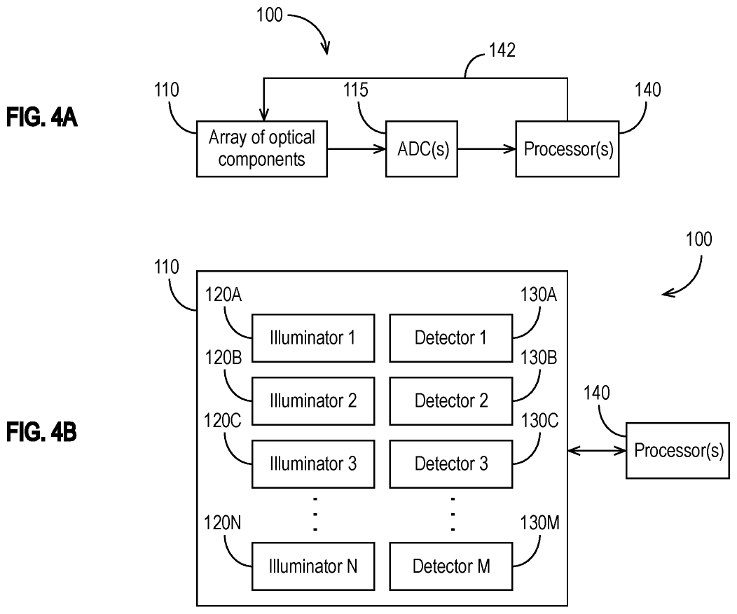

FIG. 4A is a diagram of certain components of a LiDAR system 100 for carrying out target identification and position estimation in accordance with some embodiments. The LiDAR system 100 includes an array of optical components 110 coupled to at least one processor 140. The at least one processor 140 may be, for example, a digital signal processor, a microprocessor, a controller, an application-specific integrated circuit, or any other suitable hardware component (which may be suitable to process analog and/or digital signals). The at least one processor 140 may provide control signals 142 to the array of optical components 110. The control signals 142 may, for example, cause one or more illuminators in the array of optical components 110 to emit optical signals (e.g., light) sequentially or simultaneously. The control signals 142 may cause the illuminators to emit optical signals in the form of pulse sequences, which may be different for different illuminators.

The array of optical components 110 may be in the same physical housing (or enclosure) as the at least one processor 140, or it may be physically separate. Although the description herein refers to a single array of optical components 110, it is to be understood that the illuminators 120 may be in one array, and the detectors 130 may be in another array, and these arrays may be separate (logically and/or physically), depending on how the illuminators 120 and detectors 130 are situated.

The LiDAR system 100 may optionally also include one or more analog-to-digital converters (ADCs) 115 disposed between the array of optical components 110 and the at least one processor 140. If present, the one or more ADCs 115 convert analog signals provided by detectors in the array of optical components 110 to digital format for processing by the at least one processor 140. The analog signal provided by each of the detectors may be a superposition of reflected optical signals detected by that detector, which the at least one processor 140 may then process to determine the positions of targets 150 corresponding to (causing) the reflected optical signals.

FIG. 4B is more detailed diagram of the array of optical components 110 of a LiDAR system 100 in accordance with some embodiments. As shown, the array of optical components 110 includes a plurality of illuminators 120 and a plurality of detectors 130. (As stated previously, the reference number 120 is used herein to refer to illuminators generally, and the reference number 120 with a letter appended is used to refer to individual illuminators. Similarly, the reference number 130 is used herein to refer to detectors generally, and the reference number 130 with a letter appended is used to refer to individual detectors.) Although FIG. 4B illustrates the illuminator 120A, the illuminator 120B, the illuminators 120C, and the illuminator 120N, thereby suggesting that there are fourteen illuminators 120 in the array of optical components 110, it is to be understood that, as used herein, the word “plurality” means “two or more.” Therefore, the array of optical components 110 may include as few as two illuminators 120, or it may include any number of illuminators 120 greater than two. Likewise, although FIG. 4B illustrates the detector 130A, the detector 130B, the detector 130C, and the detector 130M, thereby suggesting that there are thirteen detectors 130 in the array of optical components 110, it is to be understood that the array of optical components 110 may include as few as two detectors 130, or it may include any number of detectors 130 greater than two.

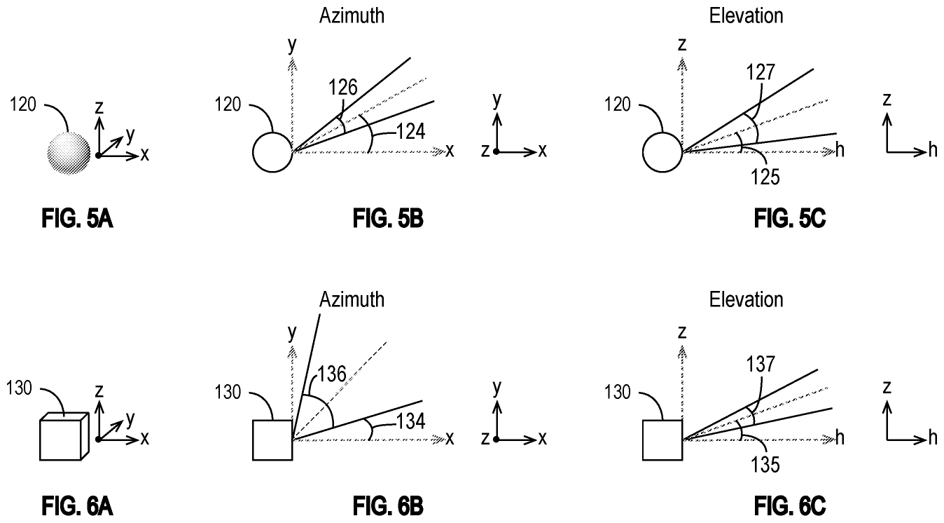

FIGS. 5A, 5B, and 5C depict an illuminator 120 in accordance with some embodiments. The illuminator 120 may be, for example, a laser operating at any suitable wavelength, for example, 905 nm or 1550 nm. The illuminator 120 is shown having a spherical shape, which is merely symbolic. In an implementation, the illuminators 120 in the array of optical components 110 may be of any suitable size and shape. The illuminators 120 may be equipped with a lens (not shown) to focus and direct the optical signals it emits, as is known in the art. In addition, some or all of the illuminators 120 may also include one or more mirrors to direct the emitted optical signal in a specified direction. An illuminator 120 may also contain a diffuser to give its field of view a specified shape (square, rectangle, circle, ellipse, etc.) and to promote uniformity of the transmitted beam across its field of view.

Each illuminator 120 in the array of optical components 110 has a position in three-dimensional space, which can be characterized by Cartesian coordinates (x,y,z) on x-, y-, and z-axes, as shown in FIG. 5A. Alternatively, any other coordinate system could be used (e.g., spherical).

As illustrated in FIG. 5B, in addition to having a position in three-dimensional space, each illuminator 120 has two azimuth angles: an azimuth boresight angle 124 and an azimuth field-of-view (FOV) angle 126. The azimuth angles (azimuth boresight angle 124, azimuth FOV angle 126) are in a horizontal plane, which, using the coordinate system provided in FIG. 5A, is an x-y plane at some value of z. In other words, the azimuth boresight angle 124 and azimuth FOV angle 126 specify the “left-to-right” characteristics of optical signals emitted by the illuminator 120. The azimuth boresight angle 124 specifies the direction in which the illuminator 120 is pointed, which determines the general direction in which optical signals emitted by the illuminator 120 propagate. The azimuth FOV angle 126 specifies the angular width (e.g., beam width in the horizontal direction) of the portion of the scene illuminated by optical signals emitted by the illuminator 120.

As shown in FIG. 5C, each illuminator 120 also has two elevation angles: an elevation boresight angle 125 and an elevation FOV angle 127. The elevation angles are relative to a horizontal plane, which, using the coordinate system provided in FIG. 5A, is an x-y plane at some value of z. Accordingly, the horizontal axis shown in FIG. 5C is labeled “h” to indicate it is in some direction in an x-y plane that is not necessarily parallel to the x- or y-axis. (The direction of the “h” axis depends on the azimuth boresight angle 124.) The elevation boresight angle 125 and elevation FOV angle 127 specify the “up-and-down” characteristics of optical signals emitted by the illuminator 120. The elevation boresight angle 125 determines the height or altitude at which the illuminator 120 is pointed, which determines the general direction in which optical signals emitted by the illuminator 120 propagate. The elevation FOV angle 127 specifies the angular height (e.g., beam width in the vertical direction) of the portion of the scene illuminated by optical signals emitted by the illuminator 120.

The elevation FOV angle 127 of an illuminator 120 may be the same as or different from the azimuth FOV angle 126 of that illuminator 120. As will be understood by those having ordinary skill in the art, the beams emitted by illuminators 120 can have any suitable shape in three dimensions. For example, the emitted beams may be generally conical (where a cone is an object made up of a collection of (infinitely many) rays). The cross section of the cone can be any arbitrary shape, e.g., circular, ellipsoidal, square, rectangular, etc.

The volume of space illuminated by an illuminator 120 having an azimuth boresight angle 124, an elevation boresight angle 125, an azimuth FOV angle 126, and an elevation FOV angle 127 is referred to herein as the illuminator FOV 122. Objects that are within the illuminator FOV 122 of a particular illuminator 120 are illuminated by optical signals transmitted by that illuminator 120. The illuminator FOV 122 of an illuminator 120 is dependent on and determined by the position of the illuminator 120 within the array of optical components 110, and the azimuth boresight angle 124, the elevation boresight angle 125, the azimuth FOV angle 126, and the elevation FOV angle 127 of the illuminator 120. The range of the illuminator 120 is dependent on the optical power.

The array of optical components 110 includes a plurality of illuminators 120, which may be identical to each other, or they may differ in one or more characteristics. For example, different illuminators 120 have different positions in the array of optical components 110 and therefore in space (i.e., they have different (x,y,z) coordinates). The azimuth boresight angle 124, the elevation boresight angle 125, the azimuth FOV angle 126, and the elevation FOV angle 127 of different illuminators 120 may also be the same or different. For example, subsets of illuminators 120 may have configurations whereby they illuminate primarily targets within a certain range of the LiDAR system 100 and are used in connection with detectors 130 that are configured primarily to detect targets within that same range. Similarly, the power of optical signals emitted by different illuminators 120 can be the same or different. For example, illuminators 120 intended to illuminate targets far from the LiDAR system 100 may use more power than illuminators 120 intended to illuminate targets close to the LiDAR system 100. Another way to extend the range of targets illuminated by illuminators 120 is to incorporate repetition of transmitted pulse sequences and/or to add/accumulate and/or average the received reflected signals at the detectors 130. This type of approach can increase the received SNR without increasing the transmit power.

The azimuth boresight angle 124, the elevation boresight angle 125, the azimuth FOV angle 126, and the elevation FOV angle 127 of the illuminators 120 in the array of optical components 110 can be selected so that the beams emitted by different illuminators 120 overlap, thereby resulting in different illuminators 120 illuminating overlapping portions of a scene (and volumes of space 160). Unlike conventional LiDAR systems, the LiDAR systems 100 herein are able to resolve the three-dimensional positions of multiple targets within these overlapping regions of space. Moreover, they do not require any moving parts. The array of optical components 110 can be stationary.

FIGS. 6A, 6B, and 6C depict a detector 130 in accordance with some embodiments. The detector 130 may be, for example, a photodetector. In some embodiments, the detector 130 is an avalanche photodiode. As will be appreciated by those having ordinary skill in the art, avalanche photodiodes operate under a high reverse-bias condition, which results in avalanche multiplication of the holes and electrons created by photon impact. As a photon enters the depletion region of the photodiode and creates an electron-hole pair, the created charge carriers are pulled away from each other by the electric field. Their velocity increases, and when they collide with the lattice, they create additional electron-hole pairs, which are then pulled away from each other, collide with the lattice, and create yet more electron-hole pairs, etc. The avalanche process increases the gain of the diode, which provides a higher sensitivity level than an ordinary diode. Like the illuminator 120, the detector 130 may include a lens to focus the received signal. In addition, like the illuminator 120, the detector 130 may include one or more mirrors to direct the received light in a selected direction.

The detector 130 is shown having a cuboid shape, which is merely symbolic. Throughout this document, solely to allow illuminators 120 and detectors 130 to be distinguished easily, illuminators 120 are shown as circular or spherical and detectors 130 are shown as cuboid or square. In an implementation, the detectors 130 in the array of optical components 110 may be of any suitable size and shape.

Each detector 130 in the array of optical components 110 has a position in three-dimensional space, which, as explained previously, can be characterized by Cartesian coordinates (x,y,z) on x-, y-, and z-axes, as shown in FIG. 6A. Alternatively, any other coordinate system could be used (e.g., spherical).

As illustrated in FIG. 6B, in addition to having a position in three-dimensional space, each detector 130 has two azimuth angles: an azimuth boresight angle 134 and an azimuth FOV angle 136. As is the case for the illuminators 120, the azimuth angles of the detectors 130 are in a horizontal plane, which, using the coordinate system provided in FIG. 6A, is an x-y plane at some value of z. In other words, the azimuth boresight angle 134 and azimuth FOV angle 136 specify the “left-to-right” positioning of the detector 130 (e.g., where in the horizontal plane it is “looking”). The azimuth boresight angle 134 specifies the direction in which the detector 130 is pointed, which determines the general direction in which it detects optical signals. The azimuth FOV angle 136 specifies the angular width in the horizontal direction of the portion of the scene sensed by the detector 130.

As shown in FIG. 6C, each detector 130 also has two elevation angles: an elevation boresight angle 135 and an elevation FOV angle 137. The elevation angles are relative to a horizontal plane, which, using the coordinate system provided in FIG. 6A, is an x-y plane at some value of z. Accordingly, the horizontal axis shown in FIG. 6C is labeled “h” to indicate it is in some direction in an x-y plane that is not necessarily parallel to the x- or y-axis. (The direction of the “h” axis depends on the azimuth boresight angle 134.) The elevation boresight angle 135 and elevation FOV angle 137 specify the “up-and-down” positioning of the detector 130. The elevation boresight angle 135 determines the height or altitude at which the detector 130 is directed, which determines the general direction in which it detects optical signals. The elevation FOV angle 137 specifies the angular height (e.g., beam width in the vertical direction) of the portion of the scene sensed by the detector 130. The elevation FOV angle 137 of a detector 130 may be the same as or different from the azimuth FOV angle 136 of that detector 130. In other words, the vertical span of the detector 130 may be the same as or different from its horizontal span.

The volume of space sensed by a detector 130 having an azimuth boresight angle 134, an elevation boresight angle 135, an azimuth FOV angle 136, and an elevation FOV angle 137 is referred to herein as a detector FOV 132. Optical signals reflected by objects within a particular detector 130's detector FOV 132 can be detected by that detector 130. The detector FOV 132 of a detector 130 is dependent on and determined by the position of the detector 130 within the array of optical components, and the azimuth boresight angle 134, the elevation boresight angle 135, the azimuth FOV angle 136, and the elevation FOV angle 137 of the detector 130. The range of the detector 130 is dependent on the sensitivity of the detector 130.

The detectors 130 in the array of optical components 110 may be identical to each other, or they may differ in one or more characteristics. For example, different detectors 130 have different positions in the array of optical components 110 and therefore in space (i.e., they have different (x,y,z) coordinates). The azimuth boresight angle 134, the elevation boresight angle 135, the azimuth FOV angle 136, and the elevation FOV angle 137 of different detectors 130 may also be the same or different. For example, subsets of detectors 130 may have configurations whereby they observe targets within a certain range of the LiDAR system 100 and are used in connection with illuminators 120 that are configured primarily to illuminate targets within that same range.

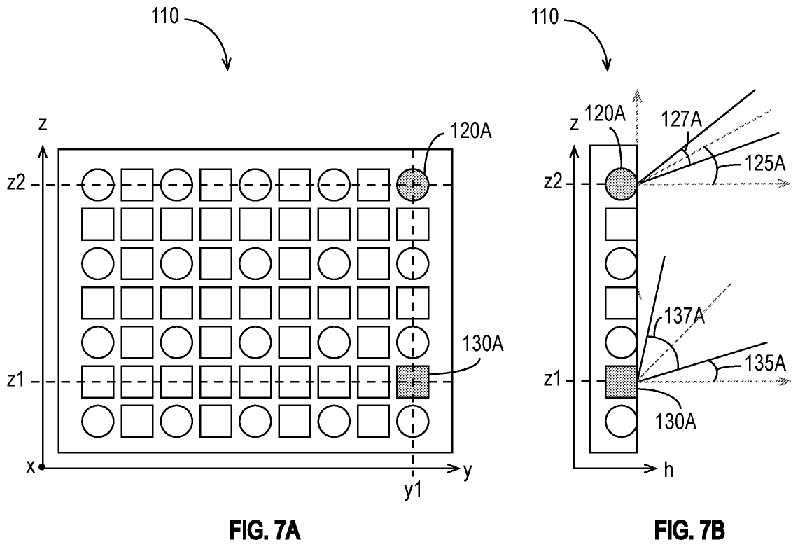

FIGS. 7A and 7B are representations of an array of optical components 110 in accordance with some embodiments. FIG. 7A is a “straight-on” view of the array of optical components 110 in a y-z plane, meaning that optical signals emitted by the illuminators 120 would come out of the page at various azimuth boresight angles 124 and elevation boresight angles 125 and having various azimuth FOV angles 126 and elevation FOV angles 127, and optical signals reflected by objects (targets 150) would be sensed by the detectors 130 having various azimuth boresight angles 134 and elevation boresight angles 135 and having various azimuth FOV angles 136 and elevation FOV angles 137 that also come out of the page. Per the convention described earlier, the illuminators 120 are represented by circles, most of which are unlabeled, and the detectors 130 are represented by squares, most of which are also unlabeled. The illustrated exemplary array of optical components 110 includes more detectors 130 than illuminators 120. As explained previously, an array of optical components 110 can have equal or unequal numbers of illuminators 120 and detectors 130. There may be, for example, more illuminators 120 than detectors 130. There may be an equal number of illuminators 120 and detectors 130. In general, the array of optical components 110 has a plurality of illuminators 120 (which may differ in various respects as described above) and a plurality of detectors 130 (which may differ in various respects as described above).

FIG. 7A labels one illuminator 120A, which has a position (coordinates) given by some value of x as well as y1 and z2. If the x-value is assumed to be 0, the position of the illuminator 120A in Cartesian coordinates is (0, y1, z2). FIG. 7A also labels one detector 130A, which has a position (0, y1, z1) under the assumption that the value of x is 0.

FIG. 7B is a simplified cross-sectional view of the array of optical components 110 at the position y1. The horizontal axis in FIG. 7B is labeled as “h,” but it is to be noted that the elevation angles of the illuminator 120A and the detector 130A need not be at the same azimuth boresight angle 124 and azimuth boresight angle 134. In other words, as described above, different illuminators 120 and/or detectors 130 may be oriented in different directions. As shown, the illuminator 120A emits optical signals at an elevation boresight angle 125A with an elevation FOV 127A. Similarly, the detector 130A is oriented at an elevation boresight angle 135A and has an elevation FOV 137A.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used herein, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used herein, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used herein, such terms are intended to be inclusive in a manner similar to the term “comprising,” i.e., meaning “including but not limited to.”

The terms “exemplary” and “embodiment” are used to express examples, not preferences or requirements.

The term “coupled” is used herein to express a direct connection/attachment as well as a connection/attachment through one or more intervening elements or structures.

The terms “over,” “under,” “between,” and “on” are used herein refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales. As another example, a structure that is “substantially vertical” would be considered to be vertical for all practical purposes, even if it is not precisely at 90 degrees relative to horizontal.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. A light detection and ranging (LiDAR) system, comprising:
an array of optical components, the array comprising:
n₁ illuminators configured to illuminate a point in space, and
n₂ detectors configured to observe the point in space,
wherein n₁×n₂>2 and the n₁ illuminators and n₂ detectors are situated in a non-collinear arrangement; and
at least one processor coupled to the array of optical components and configured to:
determine a first time-of-flight set corresponding to a first location of the LiDAR system at a first time, wherein the first time-of-flight set includes a respective entry for each unique illuminator-detector pair of the n₁ illuminators and n₂ detectors, wherein the first time-of-flight set includes, for each unique illuminator-detector pair, a respective measured time-of-flight of a first optical signal emitted by an illuminator of the unique illuminator-detector pair at the first time and from the first location, reflected by a target at the point in space, and detected by a detector of the unique illuminator-detector pair,
determine a second time-of-flight set corresponding to a second location of the LiDAR system at a second time, wherein the second time-of-flight set includes a respective entry for each unique illuminator-detector pair of the n₁ illuminators and n₂ detectors, wherein the second time-of-flight set includes, for each unique illuminator-detector pair, a respective measured time-of-flight of a second optical signal emitted by the illuminator of the unique illuminator-detector pair at the second time and from the second location, reflected by the target, and detected by the detector of the unique illuminator-detector pair, and
solve an optimization problem to estimate a position of the target, wherein the optimization problem minimizes a cost function that takes into account the first time-of-flight set and the second time-of-flight set.

2. The LiDAR system recited in claim 1, wherein the cost function is a function of at least (a) coordinates of the n₁ illuminators, (b) coordinates of the n₂ detectors, (c) the first time-of-flight set, and (d) the second time-of-flight set.

3. The LiDAR system recited in claim 1, wherein the cost function is quadratic.

4. The LiDAR system recited in claim 1, wherein the at least one processor is configured to solve the optimization problem, in part, by minimizing a sum of (a) squared differences between each entry in the first time-of-flight set and a respective first estimated time-of-flight, wherein the respective first estimated time-of-flight is calculated from known coordinates of the respective illuminator-detector pair at the first time and an unknown position of the target, and (b) squared differences between each entry in the second time-of-flight set and a respective second estimated time-of-flight, wherein the respective second estimated time-of-flight is calculated from known coordinates of the respective illuminator-detector pair at the second time and the unknown position of the target.

5. The LiDAR system recited in claim 4, wherein the n₁ illuminators comprise a first illuminator and a second illuminator and the n₂ detectors comprise a first detector and a second detector.

6. The LiDAR system recited in claim 5, wherein the optimization problem is
$${min}_{X} {\sum }_{t = 1}^{2} {( ‖ X - {l}_{t , 1} ‖ + ‖ X - {a}_{t , 1} ‖ - c {τ}_{t , 11} )}^{2} + {( ‖ X - {l}_{t , 1} ‖ + ‖ X - {a}_{t , 2} ‖ - c {τ}_{t , 12} )}^{2} + {( ‖ X - {l}_{t , 2} ‖ + ‖ X - {a}_{t , 1} ‖ - c {τ}_{t , 21} )}^{2} + {( ‖ X - {l}_{t , 2} ‖ + ‖ X - {a}_{t , 2} ‖ - c {τ}_{t , 22} )}^{2}$$
wherein:
X is a first vector representing the position of the target,
l_{t,1} is a second vector representing coordinates of the first illuminator at a time t,
l_{t,2} is a third vector representing coordinates of the second illuminator at the time t,
α_{t,1} is a fourth vector representing coordinates of the first detector at the time t,
α_{t,2} is a fifth vector representing coordinates of the second detector at the time t,
c is a speed of light,
τ_{t,11} is the measured time-of-flight of the first optical signal emitted by the first illuminator at the time t, reflected by the target, and detected by the first detector,
τ_{t,12} is the measured time-of-flight of the first optical signal emitted by the first illuminator at the time t, reflected by the target, and detected by the second detector,
τ_{t,21} is the measured time-of-flight of the first optical signal emitted by the second illuminator at the time t, reflected by the target, and detected by the first detector, and
τ_{t,22} is the measured time-of-flight of the first optical signal emitted by the second illuminator at the time t, reflected by the target, and detected by the second detector.

7. The LiDAR system recited in claim 1, wherein the at least one processor is further configured to:
determine a third time-of-flight set corresponding to a third location of the LiDAR system at a third time, wherein the third time-of-flight set includes a respective entry for each unique illuminator-detector pair of the n₁ illuminators and n₂ detectors, wherein the third time-of-flight set includes, for each unique illuminator-detector pair, a respective measured time-of-flight of a third optical signal emitted by the illuminator of the unique illuminator-detector pair at the third time and from the third location, reflected by the target, and detected by the detector of the unique illuminator-detector pair,
and wherein the cost function takes into account the third time-of-flight set.

8. The LiDAR system recited in claim 7, wherein the n₁ illuminators comprise a first illuminator and a second illuminator and the n₂ detectors comprise a first detector and a second detector, and wherein the optimization problem is
$${min}_{X} {\sum }_{t = 1}^{3} {( ‖ X - {l}_{t , 1} ‖ + ‖ X - {a}_{t , 1} ‖ - c {τ}_{t , 11} )}^{2} + {( ‖ X - {l}_{t , 1} ‖ + ‖ X - {a}_{t , 2} ‖ - c {τ}_{t , 12} )}^{2} + {( ‖ X - {l}_{t , 2} ‖ + ‖ X - {a}_{t , 1} ‖ - c {τ}_{t , 21} )}^{2} + {( ‖ X - {l}_{t , 2} ‖ + ‖ X - {a}_{t , 2} ‖ - c {τ}_{t , 22} )}^{2}$$
wherein:
X is a first vector representing the position of the target,
l_{t,1} is a second vector representing coordinates of the first illuminator at a time t,
l_{t,2} is a third vector representing coordinates of the second illuminator at the time t,
α_{t,1} is a fourth vector representing coordinates of the first detector at the time t,
α_{t,2} is a fifth vector representing coordinates of the second detector at the time t, c is a speed of light,
τ_{t,11} is the measured time-of-flight of the first optical signal emitted by the first illuminator at the time t, reflected by the target, and detected by the first detector,
τ_{t,12} is the measured time-of-flight of the first optical signal emitted by the first illuminator at the time t, reflected by the target, and detected by the second detector,
τ_{t,21} is the measured time-of-flight of the first optical signal emitted by the second illuminator at the time t, reflected by the target, and detected by the first detector, and
τ_{t,22} is the measured time-of-flight of the first optical signal emitted by the second illuminator at the time t, reflected by the target, and detected by the second detector.

9. (canceled)

10. The LiDAR system recited in claim 1, further comprising an inertial navigation system (INS) or a Global Navigation Satellite System (GNSS) coupled to the at least one processor and configured to:
determine a first estimate of the first location of the LiDAR system at the first time and/or determine a second estimate of the second location of the LiDAR system at the second time,
and wherein the at least one processor is further configured to obtain the first estimate and/or the second estimate from the INS or GNSS.

11. The LiDAR system recited in claim 1, wherein the at least one processor is further configured to:
estimate a motion of the target.

12. The LiDAR system recited in claim 11, further comprising a radar subsystem coupled to the at least one processor, and wherein the at least one processor is configured to estimate the motion of the target using Doppler information obtained from the radar subsystem.

13. A method performed by a light detection and ranging (LiDAR) system comprising at least three unique illuminator-detector pairs, each of the at least three unique illuminator-detector pairs having one of n₁ illuminators configured to illuminate a volume of space and one of n₂ detectors configured to observe the volume of space, wherein n₁×n₂>2, and wherein the n₁ illuminators and n₂ detectors are situated in a non-collinear arrangement, the method comprising:
at each of a plurality of locations of the LiDAR system, each of the plurality of locations corresponding to a respective time, for each of the at least three unique illuminator-detector pairs, measuring a respective time-of-flight of a respective optical signal emitted by the illuminator, reflected by a target in the volume of space, and detected by the detector; and
solving an optimization problem to estimate a position of the target.

14. The method of claim 13, wherein the optimization problem minimizes a cost function that takes into account at least a subset of the measured times of flight.

15. The method of claim 14, wherein the cost function is a function of at least (a) positions of the n₁ illuminators, (b) positions of the n₂ detectors, and (c) the at least a subset of the measured times of flight.

16. The method of claim 14, wherein the cost function is quadratic.

17. The method of claim 13, wherein solving the optimization problem comprises minimizing a sum of squared differences.

18. The method of claim 13, wherein the n₁ illuminators comprise a first illuminator and a second illuminator and the n₂ detectors comprise a first detector and a second detector, and wherein the optimization problem is
$${min}_{X} {\sum }_{t = 1}^{2} {( ‖ X - {l}_{t , 1} ‖ + ‖ X - {a}_{t , 1} ‖ - c {τ}_{t , 11} )}^{2} + {( ‖ X - {l}_{t , 1} ‖ + ‖ X - {a}_{t , 2} ‖ - c {τ}_{t , 12} )}^{2} + {( ‖ X - {l}_{t , 2} ‖ + ‖ X - {a}_{t , 1} ‖ - c {τ}_{t , 21} )}^{2} + {( ‖ X - {l}_{t , 2} ‖ + ‖ X - {a}_{t , 2} ‖ - c {τ}_{t , 22} )}^{2}$$
wherein:
X is a first vector representing the position of the target,
l_{t,1} is a second vector representing coordinates of the first illuminator at a time t,
l_{t,2} is a third vector representing coordinates of the second illuminator at the time t,
α_{t,1} is a fourth vector representing coordinates of the first detector at the time t,
α_{t,2} is a fifth vector representing coordinates of the second detector at the time t, c is a speed of light,
τ_{t,11} is the measured time-of-flight of the respective optical signal emitted by the first illuminator at the time t, reflected by the target, and detected by the first detector,
τ_{t,12} is the measured time-of-flight of the respective optical signal emitted by the first illuminator at the time t, reflected by the target, and detected by the second detector,
τ_{t,21} is the measured time-of-flight of the respective optical signal emitted by the second illuminator at the time t, reflected by the target, and detected by the first detector, and
τ_{t,22} is the measured time-of-flight of the respective optical signal emitted by the second illuminator at the time t, reflected by the target, and detected by the second detector.

19. The method of claim 13, wherein the optimization problem is
$${min}_{X} {\sum }_{t = 1}^{T} {\sum }_{i = 1}^{{n}_{1}} {\sum }_{j = 1}^{{n}_{2}} f ( {‖ X - {l}_{t , i} ‖}_{2} + {‖ X - {a}_{t , j} ‖}_{2} - c \cdot {τ}_{t , i , j} )$$
wherein:
X is a first vector representing the position of the target,
l_{t,i} is a second vector representing coordinates of an ith illuminator of the n₁ illuminators at a time t,
α_{t,j} is a third vector representing coordinates of a jth detector of the n₂ detectors at the time t,
c is a speed of light,
τ_{t,ij} is the measured time-of-flight of the respective optical signal emitted by the ith illuminator at the time t, reflected by the target, and detected by the jth detector,
T is a number of measurements, and
ƒ(·) is a cost function.

20. The method of claim 19, wherein the cost function is quadratic.

21. The method of claim 19, wherein a value of Tis at least ten.

22. The method of claim 13, further comprising:
estimating each of the plurality of locations using an inertial navigation system (INS) or a Global Navigation Satellite System (GNSS).

23. The method of claim 13, further comprising:
estimating a motion of the target.

24. The method of claim 23, wherein estimating the motion of the target comprises obtaining Doppler information from a radar subsystem.

25. The method of claim 23, wherein the optimization problem jointly estimates the position of the target and the motion of the target.
